(19) United States
(12) Patent Application Publication
(10) Pub. No.: US 2011/0008088 A1
(43) Pub. Date: Jan. 13, 2011

(54) Image forming method, image forming apparatus, and process cartridge

(75) Inventors: Hiroshi Nakai, Yokohama-shi (JP); Kunio Hasegawa, Isehara-shi (JP); Shinya Tanaka, Sagamihara-shi (JP); Taichi Urayama, Ebina-shi (JP)

Correspondence Address: Harness, Dickey & Pierce P.L.C., P.O. Box 8910, Reston, VA, 20195, US

(73) Assignee: Ricoh Company, Limited

(21) Appl. No.: 12/805,106

(22) Filed: Jul. 13, 2010

(30) Foreign Application Priority Data
Jul. 13, 2009 (JP) 2009-164557

(51) Int. Cl. G03G 21/00

(52) U.S. Cl. 399/346

(57) ABSTRACT

The image forming method includes applying a protective agent including a fatty acid metal salt to a surface of an image bearing member; forming an electrostatic latent image on the surface of the image bearing member; and developing the electrostatic latent image with a developer including toner and boron nitride to form a visual image. The image forming apparatus includes an image bearing member; a latent image forming device configured to form an electrostatic latent image on a surface of the image bearing member; developing device configured to develop the electrostatic latent image with a developer including toner and boron nitride to form a visual image on the surface of the image bearing member; and a protective agent applying device configured to apply a protective agent including a fatty acid metal salt to the surface of the image bearing member.

### BACKGROUND OF THE INVENTION

1. Field of the Invention

The present invention relates to an image forming method, and more particularly to an image forming method including a process of applying or adhering a protective agent to the surface of an image bearing member. In addition, the present invention also relates to an image forming apparatus and a process cartridge, which use the image forming method.

2. Discussion of the Related Art

Electrophotographic image forming methods have been broadly used for image forming apparatus having one or more of copier, printer, facsimile and plotter functions. Such electrophotographic image forming methods typically include the following processes:

(1) An electrostatic latent image is formed on an image bearing member such as photoreceptors (latent image forming process);
(2) The electrostatic latent image is developed with a developer including charged toner to form a visual image (i.e., toner image) on the image bearing member (developing process);
(3). The visual image is transferred onto a receiving material optionally via an intermediate transfer medium (transferring process); and
(4) The visual image is fixed to the receiving material upon application of heat, pressure and/or solvent thereto to form a final image (fixing process).

Image forming apparatus using such an electrophotographic image forming method typically include a rotatable image bearing member (such as photoreceptor drums or belts); a charging device configured to charge the rotated image bearing member; a light irradiating device configured to irradiate the charged image bearing member with light to form an electrostatic latent image thereon; a developing device configured to develop the electrostatic latent image with a developer including toner to form a visual image thereon; a transferring device configured to transfer the visual image onto a receiving material; and a fixing device configured to fix the visual image to the receiving material.

In the transferring process, some toner particles remain on the image bearing member without being transferred onto a receiving material. If such residual toner particles remain on a surface of the image bearing member and the charging process is then performed thereon, the surface of the image bearing member tends to be unevenly charged. Therefore, the electrophotographic image forming methods typically include a cleaning process in which toner particles remaining on the surface of the image bearing member even after the transferring process are removed therefrom so that the cleaned surface of the image bearing member is used for the next charging process.

As mentioned above, the surface of an image bearing member receives various physical and electric stresses in the latent image forming process (such as combinations of charging process and light irradiating process), developing process, transferring process and cleaning process. Thus, the conditions of the surface of the image bearing member change with time.

Among the above-mentioned stresses, the stress in the cleaning process, which is typically caused by friction between the image bearing member and a cleaner, causes not only abrasion of the surface of the image bearing member, but also shortening of the life of the cleaning member used.

In view of cost reduction and global environmental protection (i.e., reduction of waste), the market demands to prolong the lives of image forming apparatus and parts constituting the apparatus. Therefore, the present inventors recognized that recently there is a need for long-life image bearing members and peripheral parts thereof. In addition, it is a major problem to be solved that the stress in the cleaning process is reduced.

Further, in, order to provide small-sized and low-cost image forming apparatus, contact chargers or short-range chargers have been recently used for image forming apparatus. Among these chargers, short-range chargers have a property such that when the chargers are unevenly contacted with the surface of an image bearing member, or there is uneven gap between the surface of the chargers and an image bearing member, the surface of the image bearing member cannot be evenly charged. Therefore, such short-range chargers typically use a DC/AC charging method in which an DC voltage superimposed with an AC voltage is applied to an image bearing member. Using such a short-range charger using a DC/AC charging method makes it possible to provide small-sized image forming apparatus and to produce high quality images. In addition, since an image bearing member can be evenly charged without contacted with a charger, speed in deterioration of the charger itself can be reduced. Therefore, in order to provide a miniaturized heavy duty image forming apparatus capable of producing high quality images, short-range chargers using a DC/AC charging method are preferably used.

However, application of a DC/AC voltage to an organic photoreceptor serving as an image bearing member tends to cause a problem in that polymer chains of the resins included in the surface portion of the photoreceptor are cut, thereby deteriorating the mechanical strength of the surface of the photoreceptor, resulting in serious acceleration of abrasion of the surface of the image bearing member. In addition, since application of a DC/AC voltage to an image bearing member activates the surface thereof, adhesiveness between the surface and toner is enhanced, thereby causing a problem in that the cleanability of the surface of the image bearing member deteriorates.

On the other hand, in order to produce high quality images, toner having a spherical form and a relatively small particle diameter has been developed and used recently. When such toner is used for an image forming apparatus using a DC/AC charging method, margin for cleanability of the image bearing member is seriously decreased.

In attempting to solve the problem, i.e., in attempting to reduce the friction force between an image bearing member and a cleaner to protect both the image bearing member and cleaner while improving the cleanability thereof, various lubricants (hereinafter sometimes referred to as protective agents) and various lubricant applying methods (or lubricant layer forming methods) have been proposed.

For example, a published examined Japanese patent application No. (hereinafter referred to as JP-B) 51-22380 discloses a technique of using zinc stearate as a lubricant. A published unexamined Japanese patent application No. (hereinafter referred to as JP-A) 2004-333961 discloses a technique in that a brush scrapes off a molded lubricant to apply the scraped lubricant to the surface of an image bearing member, and toner including a lubricant is used for forming images. JP-A 2009-48107 discloses a technique in that a combination of a hydrocarbon wax and a thermoplastic resin is used as a protective agent, and the developer includes a lubricating powder. JP-A 2007-304246 discloses a technique in that a toner including boron nitride as an external additive is used. JP-A 2008-134467 discloses a technique in that a fatty acid metal salt and a solid lubricant are supplied to an image bearing member from different supplying devices.

Many proposals typified by JP-B 51-22380 to use a fatty acid metal salt (such as zinc stearate) as a lubricant have been made. Using this technique can produce a good effect of protecting an image bearing member. However, such fatty acid metal salts have poor resistance to charging processes because of being organic materials. Particularly, when DC/AC charging methods are used, fatty acid metal salts easily change their properties, resulting in deterioration of lubricity thereof, thereby deteriorating the cleanability of the image bearing member. In addition, other problems in that the cleanability of the cleaner used is deteriorated with time, and the charging member used is easily contaminated with the fatty acid metal salt used are caused thereby.

Several proposals typified by JP-As 2004-333961 and 2009-48107 to scrape off a molded lubricant to apply the scraped lubricant to an image bearing member while supplying a lubricant from a toner have been made. This technique has an advantage in that a photoreceptor protection effect can be stably produced even under various conditions. However, depending on the lubricant (protective agent) used, a development problem in that development of electrostatic latent images cannot be well performed due to the lubricant applied to the surface of the image bearing member is caused. Particularly, when a fatty acid metal salt is used as a molded lubricant or a lubricant included in the toner, a development problem such that the charge quantity of the toner decreases after long repeated use, resulting in formation of images with background development in that the background portion of images is soiled with residual toner particles tends to be caused.

Many proposals typified by JP-A 2007-304246 to use toner including a particulate inorganic material (such as boron nitride) as an external additive have been made. The main purpose of these proposals is to control the charge quantity of the toner. If only a particulate inorganic material is used as a lubricant, a good lubricating effect cannot be produced. In addition, since a lubricant is supplied only from the toner, the amount of lubricant supplied to the surface of the image bearing member changes depending on the image area proportion of the produced images, and therefore a good photoreceptor protecting effect cannot be stably produced.

The proposal of JP-A 2008-134467 to supply a fatty acid metal salt and a material having a two-dimensional layer structure (such as boron nitride) using different supplying devices makes it possible to prevent the lubricity deterioration problem caused by a lubricant (such as fatty acid metal salts). However, the number of parts used for the image forming section located in the vicinity of an image bearing member (photoreceptor) increases, thereby jumboizing the image forming apparatus and increasing the costs thereof. In addition, the above-mentioned development problem may be caused thereby.

Because of these reasons, the inventors recognized that there is a need for an image forming apparatus which can produce high quality images over a long period of time with hardly causing the above-mentioned problems such as the photoreceptor abrasion problem, photoreceptor cleanability deterioration problem, charger contamination problem, and development problem.

### SUMMARY

This patent specification describes a novel image forming method. An example of the image forming method includes:

applying or adhering a protective agent to a surface of an image bearing member;

forming an electrostatic latent image on the surface of the image bearing member bearing the protective agent thereon; and

developing the electrostatic latent image with a developer to form a visual image on the surface of the image bearing member.

In this regard, the protective agent includes a fatty acid metal salt, and the developer includes toner and boron nitride.

Hereinafter, the above-mentioned protective agent applying or adhering step is sometimes referred to as a protective agent applying step.

This patent specification further describes a novel image forming apparatus. An example of the image forming apparatus includes:

an image bearing member;

a protective agent applying device configured to apply a protective agent to a surface of the image bearing member;

a latent image forming device (such as combinations of a charging device and a light irradiating device) configured to form an electrostatic latent image on the surface of the image bearing member; and

a developing device configured to develop the electrostatic latent image with a developer including toner and boron nitride to form a visual image on the surface of the image bearing member.

This patent specification further describes a novel process cartridge. An example of the process cartridge includes:

at least an image bearing member bearing an electrostatic latent image on a surface thereof;

a protective agent applying device configured to apply a protective agent to the surface of the image bearing member; and

a developing device configured to develop the electrostatic latent image with a developer including toner and boron nitride to form a visual image on the surface of the image bearing member.

The image bearing member, protective agent applying device and developing device are unitized so that the process cartridge can be detachably attachable to an image forming apparatus.

### BRIEF DESCRIPTION OF THE DRAWINGS

A more complete appreciation of the example aspects of the invention and many of the attendant advantage thereof will be readily obtained as the same better understood by reference to the following detailed description when considered in connection with the accompanying drawings, wherein:

FIG. 1 is a schematic diagram illustrating a protective agent applying device for use in the image forming apparatus of the present invention;

FIG. 2 is a schematic diagram illustrating an example of the process cartridge of the present invention;

FIG. 3 is a schematic diagram illustrating an example of the image forming apparatus of the present invention; and

FIG. 4 is a schematic view illustrating a protective agent supplying device used for Comparative Example 7.

### DESCRIPTION OF THE PREFERRED EMBODIMENTS

it will be understood that if an element or layer is referred to as being “on”, “against”, “connected to” or “coupled to” another element or layer, then it can be directly on, against, connected or coupled to the other element or layer, or intervening elements or layers may be present. In contrast, if an element is referred to as being “directly on”, “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath”, “below”, “lower”, “above”, “upper” and the like may be used herein for ease of description to describe one element or feature's relationship to another element (s) or feature (s) as illustrated, in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

In order to solve the above-mentioned problems, the present inventors have investigated various protective agents. As a result, it is discovered that by supplying a fatty acid metal salt to an image bearing member to form a protective layer on the surface of the image bearing member while supplying boron nitride thereto from the developing device, occurrence of the above-mentioned problems can be prevented.

Specifically, occurrence of the lubricity deterioration problem specific to a case where a fatty acid metal salt is used as a protective agent can be prevented by supplying boron nitride from the developing device as mentioned above with respect to the technique of JP-A 2008-134467. Since boron nitride is supplied from the developing device, jumboization of the image forming apparatus can be prevented.

In addition, by including boron nitride in the developer, occurrence of the problem in that the charge quantity of toner is decreased after long repeated use when a fatty acid metal salt is used as a protective agent can be prevented. This effect cannot be produced by a technique of using a molded lubricant including both a fatty acid metal salt and boron nitride or the technique proposed by JP-A 2008-134467 in that a fatty acid metal salt and boron nitride are supplied to an image bearing member from different supplying devices, and the effect can be produced only in a present case where boron nitride is supplied to the image bearing member from developer.

The reason why the effect can be produced only in the present case where boron nitride is supplied from developer is considered as follows. The following explanation is made by reference to a case where a two-component developer is used, but the same is true for a one-component developer, i.e., the carrier in the two-component developer case can be substituted with the developing roller in the one-component developer case.

Specifically, a part of the fatty acid metal salt layer formed on the surface of an image bearing member is scraped off by the carrier included in the developer at the developing area, and thereby the fatty acid metal salt is transferred to the surface of the carrier little by little. If the fatty acid metal salt transfer is performed for a long period of time, the amount of fatty acid metal salt on the surface of the carrier seriously increases, resulting in deterioration of the charging ability and charge quantity of the carrier. In this regard, when boron nitride is included in the developer and the developer (i.e., toner and carrier) is agitated, boron nitride forms a layer on the surface of the carrier. Even when a boron nitride layer is formed on the carrier, the boron nitride layer hardly causes the charge quantity deterioration problem. In addition, since the boron nitride layer has good lubricity, the amount of the fatty acid metal salt adhered to the surface of the carrier can be reduced, thereby preventing occurrence of the charge quantity deterioration problem.

The present inventors performed an experiment in which born nitride is replaced with another inorganic lubricant such as talc, mica, and molybdenum disulfide. The experiment shows that inorganic lubricants other than boron nitride cannot produce the above-mentioned effect of the present invention. The reason therefor is considered to be that boron nitride has good film forming property, and therefore a film having a good film property can be formed on the carrier.

Thus, the above-mentioned effect can be produced only when boron nitride is included in the developer (or developing device). In other words, the effect cannot be produced when lubricating materials other than boron nitride are included in the developer (or developing device), or when boron nitride is supplied from a supplying device other than a developing device.

The present invention is made on the basis of the experimental results.

The present invention will be explained by reference to drawings.

In the present invention, a protective agent is used to protect an image bearing member from the above-mentioned various stresses.

The protective agent used for forming a protective layer on an image bearing member preferably has the following properties:

(1) a good spreading property so as to quickly spread along the surface of the image bearing member to form an even protective layer thereon, resulting in protection of the surface of the image bearing member; and
(2) a good lubricity imparting property such that a good lubricity is imparted to the cleaner used (such as cleaning blades) to protect the cleaner.

Suitable materials for use as the protective agent include inorganic lubricants, fatty acid metal salts, waxes, oils, fluorine-containing resins, etc. Among these materials, fatty acid metal salts are preferably used in consideration of the above-mentioned requirements.

The protective agent can have a powder form or a molded form. However, a molded fatty acid metal salt having a bar form or a block form is preferably used because the added amount can be easily controlled, and jumboization of the image forming apparatus can be prevented.

Suitable methods for forming such a molded fatty acid metal salt include known methods such as melt molding methods in which a melted protective agent is injected into a mold, followed by cooling so that the protective agent is solidified; and compression molding methods in which a powder of protective agent is compressed to form a molded protective agent.

Specific examples of the fatty acid metal salts include barium stearate, lead stearate, iron stearate, nickel stearate, cobalt stearate, copper stearate, strontium stearate, calcium stearate, cadmium stearate, magnesium stearate, zinc stearate, zinc oleate, magnesiumoleate, iron oleate, cobalt oleate, copper oleate, lead oleate, manganese oleate, zinc palmitate, cobalt palmitate, lead palmitate, magnesium palmitate, aluminum palmitate, calcium palmitate, zinc caprate, lead caprate, zinc linoleate, cobalt linoleate, calciumlinoleate, zinc ricinoleate, cadmium ricinoleate, etc., but are not limited thereto. These materials can be used alone or in combination.

Among these materials, zinc stearate is preferably used as a main protective agent (i.e., the added amount is not less than 50% by weight based on the total weight of the protective agent) because of having a good film forming property.

Zinc stearate has good uniform film formability, but has poor cleanability. Specifically, a blade cleaning method is typically used for removing residual toner particles from the surface of an image bearing member. When the image bearing member having such a zinc stearate layer thereon is repeatedly subjected to charging processes (i.e., repeatedly undergoes electric stress), a problem in that residual toner particles on the image bearing member cannot be well removed therefrom (i.e., residual toner particles easily pass through the gap between the surface of the image bearing member and the tip of the cleaning member used) is caused.

When the residual toner particle passing problem is caused, images whose background is soiled with the toner particles are formed, and/or the charging member is contaminated with the toner particles, thereby unevenly charging the image bearing member, resulting in formation of defective images. The residual toner particle passing problem is seriously caused when the toner has a relatively small particle diameter, or the electric stress increases (i.e., the charging time for which the image bearing member is subjected to a charging process increases or the charge voltage increases). In addition, when the residual toner particle passing problem is frequently caused, the tip of the cleaning member is abraded, resulting in shortening of the cleaning blade.

In order to solve this problem, boron nitride is used as a lubricant, and the lubricant is supplied to the image bearing member from the developing device in the image forming apparatus of the present invention. The reason why the lubricant is supplied from the developing device is explained above.

Boron nitride has a structure such that boron atoms and nitrogen atoms form firm two-dimensional hexagonal networks (layers) while the hexagonal network layers are overlaid with each other with a relatively wide gap therebetween, and the hexagonal network layers are connected with each other only by van deer Waals force, which is a weak force. Therefore, boron nitride can be easily cleaved at the interface between the layers, namely, boron nitride has good lubricity and good film formability. In addition, since boron nitride is an inorganic material, boron nitride has good chemical and thermal stabilities. Therefore, even when repeatedly receiving electric stress, boron nitride hardly loses its lubricity unlike fatty acid metal salts.

In the present invention, it is preferable to use a boron nitride powder having an average secondary particle diameter of from 2 μm to 50 μm, and an average primary particle diameter of from 0.1 μm to 10 μm. In this regard, the fluidity of the developer typically changes depending on the average secondary particle diameter of boron nitride. Specifically, when the average secondary particle diameter is too small, the fluidity of the developer seriously deteriorates. In contrast, when the average secondary particle diameter is too large, a problem in that boron nitride is stuck between a developing sleeve (developing roller) and a doctor blade for forming a developer layer on the developing sleeve, resulting in formation of undesired white line images is caused. In contrast, the average primary particle diameter of boron nitride influences the lubricity thereof. Specifically, when the average primary particle diameter of boron nitride is too small, the lubricity thereof cannot be well exhibited. In contrast, when the average primary particle diameter is too large, a problem in that boron nitride is fixedly adhered to an image bearing member is caused, although the lubricity thereof hardly deteriorates. In addition, when the average primary particle diameter is relatively large compared with that of carrier particles, a film cannot be well formed on the carrier particles. Therefore, the average primary particle diameter of boron nitride is preferably not greater than one tenth ( 1/10) of the average particle diameter of the carrier used.

In order to supply boron nitride from the developing device, the developing device may include a mechanism for supplying boron nitride to the surface of the image bearing member. However, it is preferable that boron nitride is preliminarily mixed with toner and the mixture is supplied to the developing device.

In this regard, since the final target of supplying boron nitride is to supply boron nitride to the surface of the image bearing member, it is not preferable to strongly adhere boron nitride to the surface of the toner. Therefore, in a case where boron nitride is mixed with toner using such an agitator as to be used for mixing an external additive with toner, it is preferable to control the agitating force as weak as possible.

The present invention is different from the technique of the above-mentioned background art JP-A 2007-304246 with respect this point.

The added amount of boron nitride to the toner is determined depending on the process conditions of the image forming apparatus, but is generally from 0.01 to 1% by weight based on the weight of the toner.

Next, the present invention will be explained by reference to drawings.

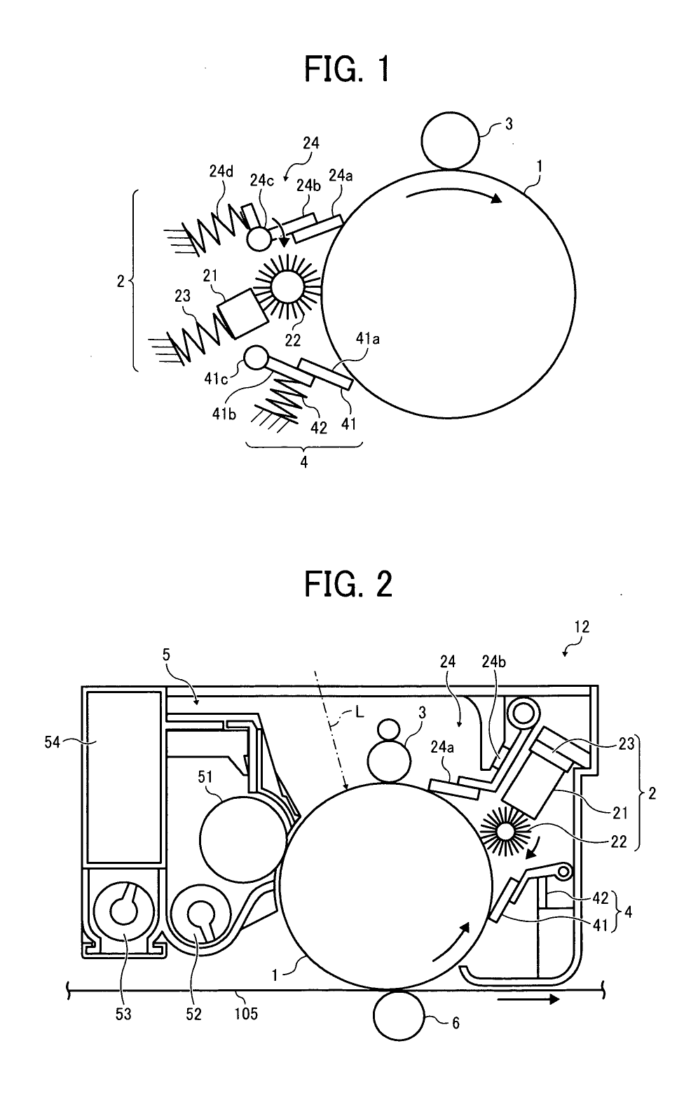

FIG. 1 is a schematic view illustrating a protective agent applying device (i.e., a protective layer forming device) for use in the image forming apparatus of the present invention.

Referring to FIG. 1, a protective agent applying device 2, which is provided so as to face a photoreceptor drum 1 serving as an image bearing member, includes an image bearing member protecting agent 21 (hereinafter referred to as a protective agent) having a bar-form or a block-form, a brush roller 22 serving as a protective agent supplying member, a pressing force applying mechanism 23 for applying a pressing force to the protective agent 21, and a protective layer forming mechanism 24 for forming a layer of the protective agent (hereinafter referred to as a protective layer) on the surface of the photoreceptor drum 1.

The protective layer forming mechanism 24 has a blade support 24b, which is rotatable on a shaft 24c, a blade 24a, whose one end (end on the side opposite to the photoreceptor side) is supported by the blade support 24b and which is contacted with the surface of the photoreceptor drum 1 in such a manner (trailing direction) as to trail the rotated photoreceptor drum, and a spring 24d, which serves as a pressing member for pressing the blade support 24b in such a direction indicated by an arrow.

Although springs are used as biasing members for biasing the pressing force applying member 23 and the protective layer forming mechanism 24, the biasing members are not limited thereto. Other elastic members such as members having a rubber elasticity, and blade springs can also be used therefor.

The protective agent 21 is pressed by the pressing force applying mechanism 23 so as to be contacted with the brush roller 22. Since the brush roller 22 rotates at a speed different from the rotating speed of the photoreceptor drum 1, the brush roller rubs the surface of the photoreceptor drum, thereby supplying the protective agent, which is born on the brush roller, to the surface of the photoreceptor drum.

The protective agent thus supplied to the surface of the photoreceptor drum is smoothed by the blade 24a of the protective layer forming mechanism 24 to form an even thin layer of the protective agent on the surface of the photoreceptor drum 1. The reason why the protective agent is subjected to the smoothing treatment is that depending on the protective agent used, an even thin layer cannot be formed only by the protective agent application operation of the brush roller 22. In this regard, a blade is used for protective layer forming mechanism, but the protective layer forming mechanism is not limited thereto.

The photoreceptor drum 1, on which the protective layer is formed, is then charged with a charging roller 3, which is a contact charger or a short-range charger and to which a DC voltage or a DC/AC voltage is applied from a high voltage power source (not shown). In this regard, the photoreceptor drum 1 is charged due to a discharge phenomenon occurring in a minor air space between the surface of the photoreceptor drum 1 and the surface of the charging roller 3. In this charging operation, a part of the protective layer is decomposed or oxidized due to the electric stress, and discharge-induced materials are adhered to the surface of the protective layer.

The thus deteriorated protective agent is removed from the surface of the photoreceptor drum 1 by a cleaning member together with residual toner particles and other residual materials. The protective agent applying device 2 may have the cleaning function, but as illustrated in FIG. 1, it is preferable to provide a cleaning device 4 on an upstream side from the protective agent applying device 2 and on a downstream side from a transferring device for transferring a toner image from the photoreceptor drum 1 to a receiving material. This is because it is hard for one device to perform both the function of removing residual materials from the surface of an image bearing member and the function of forming a protective layer on the surface at the same time under the same rubbing condition.

The cleaning device 4 includes a cleaning blade 41 serving as a cleaning member, and a cleaner pressing mechanism 42. In this protective agent applying device, a spring is used for the cleaner pressing mechanism 42. However, other elastic members such as members having a rubber elasticity, and blade springs can also be used therefor.

In FIG. 1, numerals 41a, 41b and 41c denote a cleaning blade, a cleaning blade support, and a shaft supporting the cleaning blade support, respectively. The functions of the cleaning blade support 41b and the shaft 41c are the same as those of the blade support 24b and the shaft 24c. The cleaning blade 41a is contacted with the surface of the photoreceptor drum 1 in a counter manner (i.e., in such a direction as to counter the rotated photoreceptor drum).

The material constituting the blade 24a of the protective layer forming mechanism 24 is not particularly limited. Specific examples of the material include urethane rubbers, epichlorohydrin rubbers, silicone rubbers, fluorine-containing rubbers, mixtures of these rubbers, etc. The tip portion of the blade 24a, which is to be contacted with the surface of the image bearing member, may be subjected to a coating treatment or an impregnation treatment using a material having a low friction coefficient. In addition, in order to control the hardness of the blade 24a, a filler such as organic fillers and inorganic fillers may be dispersed in the blade.

The blade 24a is fixed to the blade support 24b by using a method such as methods using an adhesive and fusion methods so that the tip of the blade can be in pressing-contact with the surface of the image bearing member.

Although the thickness of the blade 24a is determined depending on variables such as pressing force and composition of the blade, the thickness is preferably from 0.5 mm to 5 mm, and more preferably from 1 mm to 3 mm. In addition, the length of the tip portion (i.e., free portion), which is not supported by the blade support 24b, should be determined depending on variables such as pressing force and composition of the blade, but is preferably from 1 mm to 15 mm, and more preferably from 2 mm to 10 mm.

The blade 24a is not limited to such a rubber blade as mentioned above. For example, elastic metal blades (such as blade springs), on which a layer of resin, rubber or elastomer is formed using a coating or dipping method with an undercoat layer made by a coupling agent or a primer therebetween, followed by an optional crosslinking treatment and/or surface polishing treatment, can also be used. The thickness of the metal blade is preferably from 0.05 mm to 3 mm, and more preferably from 0.1 mm to 1 mm. In addition, in order to prevent such a metal blade from twisting, the metal blade may be subjected to a bending treatment in a direction substantially parallel to the shaft 24c after the blade 24a is attached. Specific examples of the material for use in the layer formed on the metal blade include fluorine-containing resins such as PFA, PTFE, FEP and PVdF, fluorine-containing rubbers, silicone elastomers such as methyl phenyl silicone elastomers, etc., but are not limited thereto. The layer may include a filler.

The pressing force of the blade 24a is not less than the force, by which the protective agent 21 can be spread on the surface of the image bearing member, resulting in formation of a protective layer, and is generally from 5 gf/cm (0.049 N/cm) to 80 gf/cm (0.784 N/cm) in linear pressure, and more preferably from 10 gf/cm (0.098 N/cm) to 60 gf/cm (0.588 N/cm).

Brush rollers (such as the brush roller 22) are preferably used as the protective agent supplying member. In order to reduce the mechanical stress which the image bearing member (photoreceptor drum 1) suffers, the fibers of the brushpreferably have flexibility.

Specific examples of the material constituting the brush fiber include resins having good flexibility such as polyolefin resins (e.g., polyethylene and polypropylene); polyvinyl or polyvinylidene resins (e.g., polystyrene, acrylic resins, polyacrylonitrile, polyvinyl acetate, polyvinyl alcohol, polyvinyl butyral, polyvinyl chloride, polyvinyl carbazole, polyvinyl ether, polyvinyl ketone, vinyl chloride-vinyl acetate copolymers, styrene-acrylic acid copolymers, and styrene-butadiene copolymers); fluorine-containing resins (e.g., polytetrafluoro ethylene, polyvinyl fluoride, polyvinylidene fluoride, and polychlorotrifluoro ethylene); polyester; nylon; acrylic resins; rayon; polyurethane; polycarbonate; phenolic resins; amino resins (e.g., urea-formaldehyde resins, melamine resins, benzoguanamine resins, urea resins and polyamide resins); etc.

In order to control the bending degree of the brush fiber, a rubber may be used in combination with the above-mentioned resins. Specific examples of such rubbers include diene rubbers, styrene-butadiene rubbers (SBR), ethylene-propylene rubbers, isoprene rubbers, nitrile rubbers, urethane rubbers, silicone rubbers, epichlorohydrin rubbers, norbornene rubbers, etc.

The protective agent bearing member (such as brush roller 22) may be a fixed roller or a rotatable roller. Specific examples of the brush roller include brush rollers such that a tape having a pile fabric is spirally wound around a metal shaft. The diameter of the fiber of the brush (pile fabric) is preferably from 10 μm to 500 μm, and the length of the fiber is preferably from 1 mm to 15 mm. The density of fibers in the brush is 10,000 to 300,000 fibers/square inch (i.e., 1.5×10⁷ to 4.5×10⁸ fibers/m²).

In order to stably form an even protective layer, the density of fibers in the brush is preferably as high as possible. It is preferable that one fiber is constituted of several to hundreds of micro fibers. For example, yarn having a thickness of 333 decitex (300 denier) constituted of 50 micro fibers each having a thickness of 6.7 decitex (6 denier) can be used for the fibers of the brush.

If necessary, a protective layer may be formed on the surface of the brush to control the shape of the brush and to impart good environmental stability to the brush. Suitable materials for use in the protective layer include any deformable materials (i.e., materials having good flexibility), which can be deformed when the fibers of the brush are bent. Specific examples of such flexible materials include polyolefin resins (e.g., polyethylene, polypropylene, chlorinated polyethylene, and chlorosulfonated polyethylene); polyvinyl or polyvinylidene resins (e.g., polystyrene, acrylic resins (such as polymethyl methacrylate), polyacrylonitrile, polyvinyl acetate, polyvinyl alcohol, polyvinyl butyral, polyvinyl chloride, polyvinyl, carbazole, polyvinyl ether, polyvinyl ketone, and vinyl chloride-vinyl acetate copolymers; silicone resins having an organo-siloxane bond and silicone resins modified with a resin such as alkyd resins, polyester resins, epoxy resins and polyurethane resins; fluorine-containing resins (e.g., perfluoroalkylether resins, polyvinyl fluoride, polyvinylidene fluoride, and polychlorotrifluoro ethylene); polyamide; polyester; polyurethane; polycarbonate; amide resins (e.g., urea-formaldehyde resins); epoxy resins; complex resins of these resins; etc.

FIG. 2 is a cross-sectional view of an example of the process cartridge of the present invention, which includes the protective agent applying device 2 mentioned above.

Referring to FIG. 2, a process cartridge 12 includes the photoreceptor drum 1, the protective agent applying device 2, the charging roller 3, a developing device 5 and the cleaning device 4, which are unitized so that the process cartridge can be detachably attachable to an image forming apparatus. The developing device 5 includes a developing roller 51 forbearing a developer layer thereon to develop an electrostatic latent image on the photoreceptor drum 1, feeding screws 52 and 53, which agitate, feed and circulate the developer, and a preset case 54 (i.e., toner container) for containing supplementary, toner.

Residual materials (such as partially deteriorated protective agent and residual toner particles) present on the surface of the photoreceptor drum 1 even after a transferring process are removed therefrom by the cleaning blade 41. The cleaning blade 41 is contacted with the surface of the photoreceptor drum in such a manner (counter manner or leading manner) as to counter the rotated photoreceptor drum.

After the surface of the photoreceptor drum 1 is cleaned by the cleaning blade 41, the protective agent supplying member 22 supplies the protective agent to the surface, and the protective layer forming mechanism 24 forms a protective layer on the surface of the photoreceptor drum.

The surface of the photoreceptor drum 1, on which the protective layer is formed, is then charged and exposed to light L (such as laser light), resulting in formation of an electrostatic latent image thereon. The electrostatic latent image is developed by the developing device 5, resulting in formation of a visual image (i.e., toner image) on the photoreceptor drum. The toner image is then transferred onto an intermediate transfer belt 105 (in an indirect transferring method) or a receiving material such as paper sheets (in a direct transferring method) by a transfer roller 6, which serves as a transferring device and which is not a member of the process cartridge 12.

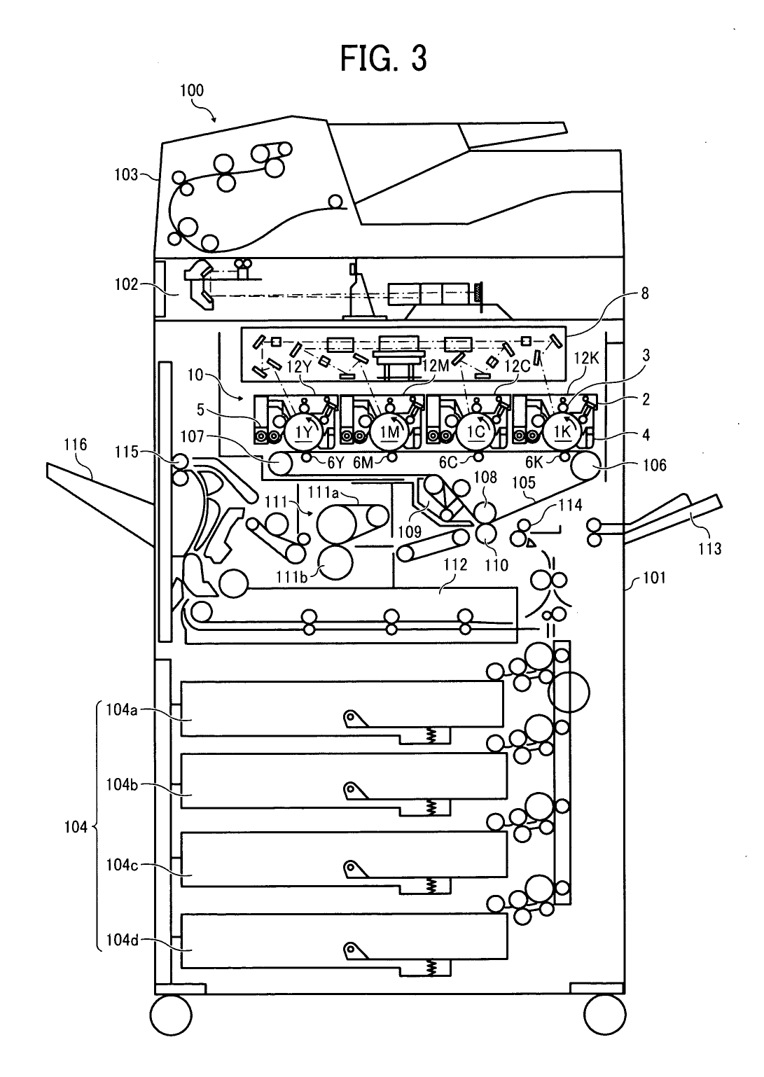

FIG. 3 is a cross-sectional view illustrating an example (tandem color copier) of the image forming apparatus of the present invention, which includes the process cartridge 12 (12Y, 12M, 12C and 12K for respectively forming yellow, magenta, cyan and black color images). Although the image forming apparatus illustrated in FIG. 3 includes the process cartridge including the protective agent applying device 2, the image forming apparatus of the present invention is not limited thereto. For example, the image forming apparatus of the present invention may be an image forming apparatus, to which the protective agent applying device 2 is directly attached independently of a process cartridge.

Referring to FIG. 3, a tandem color copier 100 includes a main body 101 of the apparatus, a scanner 102 provided above the main body 101, an automatic document feeder (ADF) 103 provided above the scanner 102, a receiving material feeding section 104, which includes plural cassettes 104a, 104b, 104c and 104d and which is provided below the main body 101.

At the center of the main body 101, the endless intermediate transfer belt 105 is arranged. The intermediate transfer belt 105 is supported by plural support rollers such as rollers 106, 107 and 108 while rotated clockwise by a driving device (not shown).

In the vicinity of the support roller 108, an intermediate transfer belt cleaning device 109 is provided to remove residual materials (such as residual toner particles) from the surface of the intermediate transfer belt 105 after a secondary transfer process.

The image forming apparatus 100 includes a tandem image forming section 10, which is constituted of the four process cartridges 12Y (for forming yellow images); 12M (for forming magenta images), 12C (for forming cyan images) and 12K (for forming black images) arranged side by side above an upper flat portion of the intermediate transfer belt 105 supported by the support rollers 106 and 107. In this regard, the order (positions) of the process cartridges 12 (i.e., the order of 12Y-12M-12C-12K) is not limited thereto.

A light irradiating device 8 configured to irradiate the charged photoreceptor drum with light is provided above the tandem image forming section 10. A secondary transfer roller 110 serving as a transferring device is provided so as to face the support roller 108 with the intermediate transfer belt 105 therebetween. The secondary transfer roller 110 transfers a combined toner image consisting of Y, M, C and K color toner images formed on the intermediate transfer belt to a sheet of the receiving material, which is supplied from the receiving material feeding section 104 and which is timely fed by a pair of registration rollers 114.

A fixing device 111 configured to fix the combined toner image on the receiving material sheet to form a fixed full color image on the receiving material sheet is provided on the left side of the secondary transfer roller 110. The fixing device 111 has a structure such that a pressure roller 111b is pressed to an endless belt 111a, which serves as a fixing member and which is heated and rotated by plural rollers.

A sheet reversing device 112 configured to reverse a receiving material sheet bearing a fixed color image thereon to prepare a double-sided copy is provided below the fixing device 111 while extending in a direction parallel to the tandem image forming section 10.

Next, an example of the image forming process (nega-posi process) of the image forming apparatus will be explained.

At first, the photoreceptor drum 1 (typified by organic photoreceptors) is subjected to a discharging process using a discharging device such as discharging lamps (not shown) to reduce residual charges. The peripheral surface of the thus discharged photoreceptor drum is evenly charged negatively with the charging roller 3 (illustrated in FIG. 1 or 2).

In the charging process, a proper voltage (such as DC voltages or DC/AC voltages) is applied to the charging roller 3 by a voltage application device (not shown) so that the photoreceptor drum has a proper negative potential.

The thus charged photoreceptor drum 1 is exposed to light (such as laser light) emitted by the light irradiating device 8 to form an electrostatic latent image thereon such that a light irradiated portion of the photoreceptor drum has a lower negative potential than a non-irradiated portion. In this regard, laser light emitted by a laser diode of the light irradiating device is reflected from a polygon mirror or the like, which rotates at a high speed, so that the charged surface of the photoreceptor drum 1 is scanned with the deflected light beam in a direction (i.e., main scanning direction) parallel to the rotating axis of the photoreceptor drum, resulting in formation of an electrostatic latent image on the surface of the photoreceptor drum.

The thus prepared electrostatic latent image is developed with a developer such as toner (i.e., one component developer) or mixtures of toner and carrier (i.e., two-component developer), which is supplied to the developing roller 51, resulting in formation of a visual toner image on the photoreceptor drum 1.

In the development process, a development bias having a proper DC voltage between the potential of the irradiated portion of the photoreceptor and the potential of the non-irradiated portion thereof or a proper DC/AC voltage, in which a DC voltage is superimposed with an AC voltage, is applied to the developing roller 51 to accelerate transferring of toner particles to the electrostatic latent image.

Color toner images formed on the four photoreceptor drums 1Y, 1M, 1C and 1K are sequentially transferred onto the intermediate transfer belt 105 by the primary transfer rollers 6 (6Y, 6M, 6C and 6K) so as to be overlaid, resulting in formation of a combined color toner image on the intermediate transfer belt. The combined color toner image is transferred by the secondary transfer roller 110 onto a receiving material sheet, which is supplied from the receiving material feeding section 104 or a manual sheet feeding tray 113 and which is timely fed by the pair of registration rollers 114. It is preferable to apply a voltage (i.e., a transfer bias) having a polarity opposite to the polarity of the charge of the toner to the transfer roller 6 to well transfer the toner image onto the receiving material sheet.

Toner particles remaining on the photoreceptor drum 1 even after a primary transferring process are removed therefrom by the cleaning blade 41, and the collected toner particles are fed to a chamber in the cleaning device 4.

The receiving material sheet bearing the combined color toner image thereon is fed to the fixing device 111, so that the combined toner image is fixed to the receiving material sheet upon application of heat and pressure thereto, resulting in formation of a copy (final image). The copy sheet is then discharged from the main body 101 so as to be stacked on a copy tray 116 by a pair of discharging rollers 115.

When a double-sided copy is formed, the copy sheet bearing a fixed color image thereon is fed to the reversing device 112 so as to be reversed and fed again to the secondary transfer position (i.e., the nip between the transfer roller 110 and the intermediate transfer belt 105). After another combined color image is transferred onto the opposite surface of the copy sheet, followed by fixation of the image, the double-sided copy is discharged from the main body 101 so as to be stacked on the copy tray 116 by the pair of discharging rollers 115.

After the secondary transfer process, the surface of the intermediate transfer belt 105 is cleaned by the intermediate transfer belt cleaning device 109 so as to be ready for the next secondary transfer process.

The image forming apparatus of the present invention is not limited to the above-mentioned tandem image forming apparatus using an intermediate transfer medium. For example, the image forming apparatus of the present invention includes a tandem image forming apparatus using no intermediate transfer medium (i.e., an image forming apparatus using a direct transfer method), in which color toner images formed on the photoreceptor drums are sequentially transferred onto a receiving material sheet.

In addition, the charging device of the image forming apparatus is preferably a contact charger or a short-range charger, because the amount of ozone generated in the charging process is very small compared with corona chargers using a discharge wire such as corotrons and scorotrons. However, when using a contact or short-range charger, discharging phenomenon occurs in the vicinity of the surface of the image bearing member.

Therefore, the image bearing member tends to receive a relatively large electric stress. By forming a protective layer on the image bearing member using such a protective agent and a protective agent applying device as mentioned above, deterioration of the image bearing member can be reduced. In addition, variation of image qualities can be reduced even when environmental conditions vary. Therefore, high quality images can be stably produced over a long period of time by the image forming apparatus of the present invention.

Having generally described this invention, further understanding can be obtained by, reference to certain specific examples which are provided herein for the purpose of illustration only and are not intended to be limiting. In the descriptions in the following examples, the numbers represent weight ratios in parts, unless otherwise specified.

### EXAMPLES

### Examples 1-5

Each of the fatty acid metal salts listed in Table 1 was melted and molded to prepare a molded protective agent. The molded protective agent was set in a color laser printer IPSIO CX9000 from Ricoh Co., Ltd.

TABLE 1

| | Fatty acid metal salt |
|---|---|
| Example 1 | Zinc laurate |
| Example 2 | Zinc palmitate |
| Example 3 | Mixture of zinc palmitate (P) and zinc stearate |
| | (S) in a weight ratio (P/S) of 6/4 |
| Example 4 | Mixture of zinc palmitate (P) and zinc stearate |
| | (S) in a weight ratio (P/S) of 4/6 |
| Example 5 | Zinc stearate |

Next, the toner of the printer used for forming black images was extracted from the black toner container of the color laser printer. A boron nitride powder (B) having an average primary particle diameter of 0.3 μm and an average secondary particle diameter of 8 μm was mixed with the toner (T) in a weight ratio (B/T) of 0.5/100, and the mixture was agitated for 10 minutes using a TURBULA mixer. The mixture (M) was further mixed with a ferrite carrier (C) having an average particle diameter of 50 μm in a weight ratio (M/C) of 5/95. The mixture was agitated for 5 minutes by the TURBULA mixer to prepare a two component developer. The initial charge quantity (Q/M) of the developer was −35 μC/g. The thus prepared developer was contained in the developing device of the printer. In addition, the mixture of the toner and boron nitride was contained as a supplementary toner in the black toner container. The average primary and secondary particle diameters of the boron nitride powder were determined by observing the powder with a scanning electron microscope and analyzing the particle image.

Evaluation of the above-prepared developers was performed as follows.

Each of the above-prepared developers and the corresponding supplementary toner were set in a modified color laser printer IPSIO CX9000 from Ricoh Co., Ltd., which was modified such that the four color image forming sections (process cartridges 12) produce black toner images, and a running test, in which 60,000 copies of an original image with an image area proportion of 5% are produced, was performed. After the running test, the following properties were evaluated.

### (1) Abrasion Loss of Photoreceptor

The thickness of the photoreceptor was measured before and after the running test to determine the abrasion loss of the photosensitive layer of the photoreceptor.

### (2) Abrasion Loss of Cleaning Blade

The thickness of the tip of the cleaning blade 41a was measured before and after the running test to determine the abrasion loss of the cleaning blade.

### (3) Contamination of Charging Roller

After the running test, the charging roller was visually observed to determine whether the charging roller is contaminated with toner particles, protective agent and the like.

### (4) Background Development of Images

The images produced at the final stage of the running test were visually observed to determine whether the background of the images is soiled with toner particles (i.e., whether the background development problem is caused).

### (5) Charge Quantity (Q/M) of Developer

After the running test, the charge quantity (Q/M) of the developer was measured to be compared with the initial charge quantity.

### Examples 6 and 7

Each of the fatty acid metal salts listed in Table 2 was melted and molded to prepare a molded protective agent. The molded protective agent was set in a color copier IMAGIO MP C4500 from Ricoh Co., Ltd.

TABLE 2

| | Fatty acid metal salt |
|---|---|
| Example 6 | Mixture of zinc palmitate (P) and zinc stearate |
| | (S) in a weight ratio (P/S) of 3/7 |
| Example 7 | Zinc stearate |

Next, the black toner was extracted from the toner bottle of the color copier. A boron nitride powder (B) having an average primary particle diameter of 0.3 μm and an average secondary particle diameter of 8 μm was mixed with the toner (T) in a weight ratio (B/T) of 0.3/100, and the mixture was agitated for 10 minutes using a TURBULA mixer. The mixture (M) was further mixed with a ferrite carrier (C) having an average particle diameter of 35 μm in a weight ratio (M/C) of 7/93. The mixture was agitated for 5 minutes by the TURBULA mixer to prepare a two component developer. The initial charge quantity (Q/M) of the developer was −32 μC/g. The thus prepared developer was contained in the developing device of the copier. In addition, the mixture of the toner and boron nitride was contained as a supplementary toner in the black toner container.

Evaluation of the above-prepared developers was performed as follows.

Each of the above-prepared developers and the corresponding supplementary toner were set in a modified color copier IMAGIO MP C4500 from Ricoh Co., Ltd., which was modified such that all the color image forming sections produce black toner images, and a running test, in which copies of an original image with an image area proportion of 5% are produced, was performed. In this regard, the total length of the surface of the photoreceptor of IMAGIO MP C4500 used for producing images in this running test is the same as the length of the surface of the photoreceptor of IPSIO CX9000 used for producing images in the above-mentioned 60,000-copy running test. After the running test, the above-mentioned properties (1)-(5) were evaluated.

### Comparative Example 1

The procedure for preparation and evaluation of the developer in Example 1 was repeated except that the boron nitride powder was not added to the toner, and the protective agent was replaced with a mixture of zinc stearate (S) and the above-mentioned boron nitride powder (B) in a weight ratio (S/B) of 8/2.

### Comparative Example 2

The procedure for preparation and evaluation of the developer in Example 5 was repeated except that the boron nitride powder was not added to the toner. Zinc stearate was used as the protective agent similarly to Example 5.

### Comparative Example 3

The procedure for preparation and evaluation of the developer in Example 5 was repeated except that the boron nitride powder added to the toner was replaced with a mica powder having an average primary particle diameter of 0.5 μm, and an average secondary particle diameter of 8 μm.

### Comparative Example 4

The procedure for preparation and evaluation of the developer in Example 5 was repeated except that the boron nitride powder added to the toner was replaced with a talc powder, which has an average primary particle diameter of 0.3 μm, and an average secondary particle diameter of 3 μm and whose surface is coated with a fluorine-containing silane compound.

### Comparative Example 5

The procedure for preparation and evaluation of the developer in Example 5 was repeated except that the boron nitride powder added to the toner was replaced with a molybdenum disulfide powder having an average primary particle diameter of 0.5 μm, and an average secondary particle diameter of 10 μm.

### Comparative Example 6

The procedure for preparation and evaluation of the developer in Example 5 was repeated except that the protective agent (zinc stearate) was not used (i.e., the protective layer was not formed). Similarly to Example 5, boron nitride was added to the toner.

### Comparative Example 7

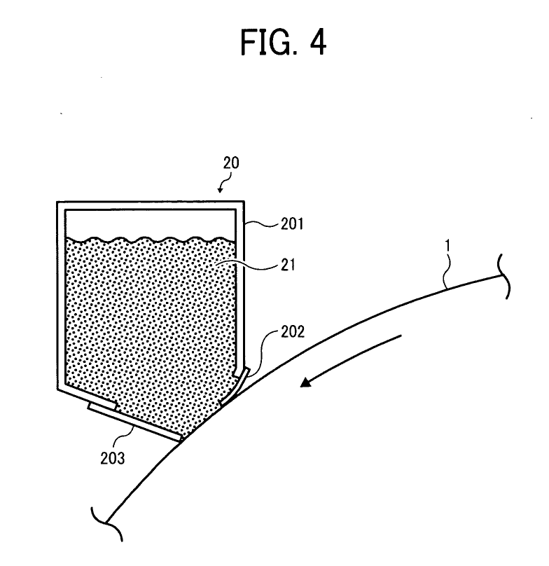

The procedure for preparation and evaluation of the developer in Example 7 was repeated except that the boron nitride powder was not added to the toner but was supplied to the surface of the photoreceptor at a position on an upstream side from the developing device of the color copier IMAGIO MP C4500. In this regard, the copier was modified so as to include a protective agent supplying device for supplying a protective agent, which is illustrated in FIG. 4. Referring to FIG. 4, a protective agent supplying device 20 includes a casing 201 configured to contain the boron nitride powder as the protective agent 21, and sealing members 202 and 203. The protective agent 21 (boron nitride powder) was supplied to the surface of the photoreceptor 1 by this protective agent supplying device 20. In this regard, the protective agent was supplied so that the weight ratio (P/T) of the protective agent (P) to the toner (T) is 0.5/100, which is the same as that of the protective agent (boron nitride powder) used for Example 7.

The evaluation results are shown in Table 3.

TABLE 3

| | Properties after running test | | | | |
|---|---|---|---|---|---|
| | Abrasion | Abrasion | Contami- | Back- | |
| | loss of | loss of | nation | ground | Charge |
| | photo- | cleaning | of charging | develop- | quantity |
| | receptor | blade | roller | ment | Q/M |
| | (μm) | (μm) | (Rank) | (Rank) | (−μC/g) |
| Ex. 1 | 2.3 | 30 | B | B | 30 |
| Ex. 2 | 1.4 | 28 | A | A | 34 |
| Ex. 3 | 1.2 | 24 | A | A | 33 |
| Ex. 4 | 0.8 | 21 | A | A | 34 |
| Ex. 5 | 0.5 | 26 | A | A | 35 |
| Ex. 6 | 0.7 | 21 | A | A | 33 |
| Ex. 7 | 0.5 | 25 | A | A | 32 |
| Comp. | 0.5 | 22 | A | C | 18 |
| Ex. 1 | | | | | |
| Comp. | 0.4 | 55 | C | C | 16 |
| Ex. 2 | | | | | |
| Comp. | 0.4 | 26 | B | C | 16 |
| Ex. 3 | | | | | |
| Comp. | 0.5 | 23 | A | C | 19 |
| Ex. 4 | | | | | |
| Comp. | 0.5 | 20 | B | C | 17 |
| Ex. 5 | | | | | |
| Comp. | 10.5 | 17 | A | A | 35 |
| Ex. 6 | | | | | |
| Comp. | 0.4 | 24 | A | C | 19 |
| Ex. 7 | | | | | |

Rank A: Excellent level
Rank B: Usable level
Rank C: Unusable level

It is clear from Table 3 that in Examples 1-7 high quality images can be produced over a long period of time while hardly causing the photoreceptor abrasion problem, blade abrasion problem, charging roller contamination problem, and background development problem.

In Examples 4-7 in which zinc stearate is used as the fatty acid metal salt, the abrasion loss of the photoreceptor is little.

It is clear from comparison of Example 5 with Comparative Example 1 and comparison of Example 7 with Comparative Example 7 that when boron nitride is included in the protective agent, or boron nitride is supplied from a position other than the developing device, the background development preventing effect cannot be produced. Namely, only when boron nitride is included in the developer, the effect can be produced.

In addition, it is clear from comparison of Example 5 with Comparative Examples 3-5 that other lubricating materials such as talc, mica and molybdenum disulfide cannot produce the background development preventing effect, and only boron nitride can produce the effect.

As described above, according to the present invention, a fatty acid metal salt adhered to the surface of an image bearing member (photoreceptor) has good protective property, and boron nitride supplied from a developing device imparts good lubricity to the image bearing member. Therefore, occurrence of abrasion of the image bearing member and cleaning blade, and contamination of a charging roller can be prevented. In addition, by supplying boron nitride from a developing device, occurrence of the background development problem caused by decrease of the charge quantity of the developer can be prevented.

Among fatty acid metal salts, zinc stearate has good photoreceptor protective property. Particularly, by using zinc stearate, abrasion of the surface (photosensitive layer) of a photoreceptor can be reduced.

When a bar-shaped fatty acid metal salt is used as a protective agent, and boron nitride is supplied in such a manner that boron nitride is preliminarily mixed with toner, and the mixture is supplied to the developer to be supplied to the surface of the image bearing member, the number of parts constituting the image forming apparatus can be reduced, and thereby the image forming apparatus can be miniaturized. In addition, the lives of parts arranged in the vicinity of the image bearing member can be prolonged.

Additional modifications and variations of the present invention are possible in light of the above teachings. It is therefore to be understood that within the scope of the appended claims the invention may be practiced other than as specifically described herein.

This document claims priority and contains subject matter related to Japanese Patent Application No. 2009-164557, filed on Jul. 13, 2009, the entire contents of which are herein incorporated by reference.

What is claimed is:

1. An image forming method comprising:
applying a protective agent including a fatty acid metal salt to a surface of an image bearing, member;
forming an electrostatic latent image on the surface of the image bearing member bearing the protective agent thereon; and
developing the electrostatic latent image with a developer including toner and boron nitride to form a visual image on the surface of the image bearing member.

2. The image forming method according to claim 1, wherein the fatty acid metal salt includes zinc stearate.

3. The image forming method according to claim 1, wherein the protective agent is molded so as to have a bar-form.

4. The image forming method according to claim 1, wherein the developing step includes:
preliminarily mixing toner with boron nitride;
supplying the mixture of toner and boron nitride to a developer including the toner and boron nitride; and
developing the electrostatic latent image with the developer to form a visual image on the surface of the image bearing member.

5. An image forming apparatus comprising:
an image bearing member;
a latent image forming device configured to form an electrostatic latent image on a surface of the image bearing member;
a developing device configured to develop the electrostatic latent image with a developer including toner and boron nitride to form a visual image on the surface of the image bearing member; and
a protective agent applying device configured to apply a protective agent including a fatty acid metal salt to the surface of the image bearing member.

6. The image forming apparatus according to claim 5, wherein the fatty acid metal salt includes zinc stearate.

7. The image forming apparatus according to claim 5, wherein the protective agent is molded so as to have a bar-form.

8. The image forming apparatus according to claim 5, wherein the developing device includes:
a toner container, which contains a mixture of the toner and boron nitride and which supplies the mixture to the developer in the developing device.

9. A process cartridge comprising:
at least an image bearing member bearing an electrostatic latent image on a surface thereof;
a developing device configured to develop the electrostatic latent image with a developer including toner and boron nitride to form a visual image on the surface of the image bearing member; and
a protective agent applying device configured to apply a protective agent including a fatty acid metal salt to the surface of the image bearing member,
wherein the image bearing member, developing device and protective agent applying device are unitized so as to be detachably attachable to an image forming apparatus.

10. The process cartridge according to claim 9, wherein the fatty acid metal salt includes zinc stearate.

11. The process cartridge according to claim 9, wherein the protective agent is molded so as to have a bar-form.

12. The process cartridge according to claim 9, wherein the developing device includes:
a toner container, which contains a mixture of the toner and boron nitride and which supplies the mixture to the developer in the developing device.
